(19) United States
(12) Patent Application Publication
(10) Pub. No.: US 2020/0014963 A1
(43) Pub. Date: Jan. 9, 2020

(54) LATENCY IMPROVEMENT VIA FRAME LATENCY FEEDBACK

(71) Applicant: QUALCOMM Incorporated, San Diego, CA (US)

(72) Inventor: Tony Gogoi, San Diego, CA (US)

(21) Appl. No.: 16/027,240

(22) Filed: Jul. 3, 2018

(51) Int. Cl. H04N 21/24; H04N 21/2662

(52) U.S. Cl. CPC H04N 21/2402; H04N 21/2662

(57) ABSTRACT

A source device may transmit video frames of a video stream over a communication link to a sink device, where each video frame corresponds to a presentation timestamp (PTS) frame comprising a frame capture time and a frame transmit start time associated with the corresponding video frame. The sink device may determine a latency metric for the video frame based at least in part on the PTS frame and a size of the video frame and generate frame latency statistics comprising frame latency information categorized by frame size into one or more categories. The source device may receive the frame latency statistics from the sink device. The source device may adjust at least one media processing parameter for the video stream based at least in part on the frame latency statistics.

### BACKGROUND

The following relates generally to wireless communication, and more specifically to latency improvement via frame latency feedback.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

In some systems, a STA (e.g., a source device) may communicate directly with another device (e.g., a sink device) to display multimedia content on the sink device. For example, a STA may wirelessly communicate multimedia content (e.g., video frames) to be displayed at a sink device. For wireless display connections between a source (e.g., a smartphone, laptop, tablet, etc.) and a sink (e.g., a TV, display, monitor, computer screen, etc.), end-to-end latency (e.g., glass-to-glass latency) is a key metric affecting user experience. For some wireless display applications, network feedback mechanisms may not provide adequate latency information.

### SUMMARY

The described techniques relate to improved methods, systems, devices, or apparatuses that support latency improvement via frame latency feedback. Generally, the described techniques provide for a mechanism or framework to report and control frame latencies (e.g., application-level or frame-level latency information). A sink device may determine and report end-to-end latency information representative of video frame latency between a display of a source device and a display of the sink device (e.g., glass-to-glass latency). The sink device may transmit frame latency statistics (e.g., a frame latency statistics report) that include aggregate frame network transmit time latency metrics and/or aggregate frame end-to-end latency metrics that are categorized (e.g., bucketized) by video frame sizes. Based on the frame-based latency statistics, the source device may adjust media processing parameters (e.g., encoding bitrate, quantization parameters, frame resolution, etc.) so as to control end-to-end frame latencies to desired levels for different user experiences (e.g., the source may adjust media processing according to latency and picture quality trade-offs).

A method of wireless communication at a source device is described. The method may include transmitting video frames of a video stream over a communication link to a sink device, where each video frame corresponds to a presentation timestamp (PTS) frame including a frame capture time and a frame transmit start time associated with the corresponding video frame. The method may further include receiving frame latency statistics from the sink device, the frame latency statistics based on the video frames and the corresponding PTS frames, and adjusting at least one media processing parameter for the video stream based on a difference between an aggregate latency for the video frames and a latency threshold (e.g., where the aggregate latency is based on the frame latency statistics).

An apparatus for wireless communication is described. The apparatus may include a processor, memory in electronic communication with the processor, and instructions stored in the memory. The instructions may be executable by the processor to cause the apparatus to transmit video frames of a video stream over a communication link to a sink device, where each video frame corresponds to a PTS frame including a frame capture time and a frame transmit start time associated with the corresponding video frame. The instructions may be executable by the processor to further cause the apparatus to receive frame latency statistics from the sink device, the frame latency statistics based on the video frames and the corresponding PTS frames, and adjust at least one media processing parameter for the video stream based on a difference between an aggregate latency for the video frames and a latency threshold, where the aggregate latency is based on the frame latency statistics.

Another apparatus for wireless communication is described. The apparatus may include means for transmitting video frames of a video stream over a communication link to a sink device, where each video frame corresponds to a PTS frame including a frame capture time and a frame transmit start time associated with the corresponding video frame. The apparatus may further include means for receiving frame latency statistics from the sink device, the frame latency statistics based on the video frames and the corresponding PTS frames, and adjusting at least one media processing parameter for the video stream based on a difference between an aggregate latency for the video frames and a latency threshold, where the aggregate latency is based on the frame latency statistics.

A non-transitory computer-readable medium storing code for wireless communication is described. The code may include instructions executable by a processor to transmit video frames of a video stream over a communication link to a sink device, where each video frame corresponds to a PTS frame including a frame capture time and a frame transmit start time associated with the corresponding video frame. The code may include instructions further executable by a processor to receive frame latency statistics from the sink device, the frame latency statistics based on the video frames and the corresponding PTS frames, and adjust at least one media processing parameter for the video stream based on a difference between an aggregate latency for the video frames and a latency threshold, where the aggregate latency is based on the frame latency statistics.

Some examples of the method, apparatuses, and non-transitory computer-readable medium described herein may further include operations, features, means, or instructions for identifying a set of aggregate frame latency metrics based on the frame latency statistics, where each aggregate frame latency metric may be associated with a respective video frame size.

In some examples of the method, apparatuses, and non-transitory computer-readable medium described herein, determining the aggregate latency may include operations, features, means, or instructions for weighting each of the aggregate frame latency metrics using a respective weighting coefficient, where each weighting coefficient may be based on the respective video frame size and determining the aggregate latency by accumulating the weighted aggregate frame latency metrics.

In some examples of the method, apparatuses, and non-transitory computer-readable medium described herein, at least one weighting coefficient, or the latency threshold, or a combination thereof may be based on a target latency associated with the video stream. In some examples of the method, apparatuses, and non-transitory computer-readable medium described herein, an aggregate network latency metric, an aggregate end-to-end metric, or some combination thereof.

In some examples of the method, apparatuses, and non-transitory computer-readable medium described herein, adjusting the at least one media processing parameter may include operations, features, means, or instructions for adjusting one or more of an encoding bitrate for the video stream, a quantization parameter for the video stream, a frame resolution parameter for the video stream, or a combination thereof.

A method of wireless communication at a sink device is described. The method may include receiving a video frame and a PTS frame from a source device, where the PTS frame includes a frame capture time and a frame transmit start time associated with the video frame and determining a latency metric for the video frame based on the PTS frame and a size of the video frame. The method may further include generating frame latency statistics including frame latency information categorized by frame size into one or more categories, where a portion of the frame latency information associated with one of the categories is based on the latency metric for the video frame, and transmitting the frame latency statistics to the source device.

An apparatus for wireless communication is described. The apparatus may include a processor, memory in electronic communication with the processor, and instructions stored in the memory. The instructions may be executable by the processor to cause the apparatus to receive a video frame and a PTS frame from a source device, where the PTS frame includes a frame capture time and a frame transmit start time associated with the video frame and determine a latency metric for the video frame based on the PTS frame and a size of the video frame. The instructions may be executable by the processor to further cause the apparatus to generate frame latency statistics including frame latency information categorized by frame size into one or more categories, where a portion of the frame latency information associated with one of the categories is based on the latency metric for the video frame, and transmit the frame latency statistics to the source device.

Another apparatus for wireless communication is described. The apparatus may include means for receiving a video frame and a PTS frame from a source device, where the PTS frame includes a frame capture time and a frame transmit start time associated with the video frame, determining a latency metric for the video frame based on the PTS frame and a size of the video frame, generating frame latency statistics including frame latency information categorized by frame size into one or more categories, where a portion of the frame latency information associated with one of the categories is based on the latency metric for the video frame, and transmitting the frame latency statistics to the source device.

A non-transitory computer-readable medium storing code for wireless communication is described. The code may include instructions executable by a processor to receive a video frame and a PTS frame from a source device, where the PTS frame includes a frame capture time and a frame transmit start time associated with the video frame, determine a latency metric for the video frame based on the PTS frame and a size of the video frame, generate frame latency statistics including frame latency information categorized by frame size into one or more categories, where a portion of the frame latency information associated with one of the categories is based on the latency metric for the video frame, and transmit the frame latency statistics to the source device.

In some examples of the method, apparatuses, and non-transitory computer-readable medium described herein, generating the frame latency statistics may include operations, features, means, or instructions for generating an aggregate frame latency metric for the one of the categories by combining the latency metric for the video frame with one or more other latency metrics, where each of the other latency metrics may be based on another video frame having a same size as the size of the video frame.

Some examples of the method, apparatuses, and non-transitory computer-readable medium described herein may further include operations, features, means, or instructions for identifying a frame receive time based on the video frame or the PTS frame, decoding the video frame and identifying a frame render time based on the decoding.

In some examples of the method, apparatuses, and non-transitory computer-readable medium described herein, the latency metric may include a frame network transmit time. Some examples of the method, apparatuses, and non-transitory computer-readable medium described herein may further include operations, features, means, or instructions for determining the frame network transmit time based on the frame transmit start time and the frame receive time. In some examples of the method, apparatuses, and non-transitory computer-readable medium described herein, the aggregate frame latency metric may include an aggregate network latency metric. Some examples of the method, apparatuses, and non-transitory computer-readable medium described herein may further include operations, features, means, or instructions for generating the aggregate network latency metric for the one of the categories by combining the frame network transmit time for the video frame with one or more other frame network transmit times, where each of the other frame network transmit times may be based on another video frame having a same size as the size of the video frame.

In some examples of the method, apparatuses, and non-transitory computer-readable medium described herein, the latency metric may include a frame end-to-end time. Some examples of the method, apparatuses, and non-transitory computer-readable medium described herein may further include operations, features, means, or instructions for determining the frame end-to-end time based on the frame capture time and the frame render time. In some examples of the method, apparatuses, and non-transitory computer-readable medium described herein, the aggregate frame latency metric may include an aggregate end-to-end latency metric. Some examples of the method, apparatuses, and non-transitory computer-readable medium described herein may further include operations, features, means, or instructions for generating the aggregate end-to-end latency metric for the one of the categories by combining the frame end-to-end time for the video frame with one or more other frame end-to-end times, where each of the other frame end-to-end times may be based on another video frame having a same size as the size of the video frame.

In some examples of the method, apparatuses, and non-transitory computer-readable medium described herein, the frame latency information categorized by frame size into one or more categories includes one or more aggregate frame latency metrics categorized by frame size into the one or more categories, one or more aggregate network latency metrics categorized by frame size into the one or more categories, or some combination thereof.

Some examples of the method, apparatuses, and non-transitory computer-readable medium described herein may further include operations, features, means, or instructions for storing the frame latency metric for a reporting duration and generating the frame latency statistics based on the stored frame latency metric and the reporting duration. Some examples of the method, apparatuses, and non-transitory computer-readable medium described herein may further include operations, features, means, or instructions for reducing the reporting duration based on the frame latency metric, where the frame latency statistics may be generated based on the reduced reporting duration.

In some examples of the method, apparatuses, and non-transitory computer-readable medium described herein, generating the frame latency statistics may include operations, features, means, or instructions for combining respective latency metrics for each of a set of frame sizes and generating an aggregate frame latency metric for each of the frame sizes based on the combining, where the frame latency statistics include the aggregate frame latency metrics categorized by their respective frame size.

### BRIEF DESCRIPTION OF THE DRAWINGS

FIG. 1 illustrates an example of a system for wireless communication that supports latency improvement via frame latency feedback in accordance with aspects of the present disclosure.

FIG. 2 illustrates an example of a process flow that supports latency improvement via frame latency feedback in accordance with aspects of the present disclosure.

FIGS. 3 through 7 show flowcharts illustrating methods that support latency improvement via frame latency feedback in accordance with aspects of the present disclosure.

FIG. 8 illustrates an example of a process flow that supports latency improvement via frame latency feedback in accordance with aspects of the present disclosure.

FIG. 9 illustrates a block diagram of a device that supports latency improvement via frame latency feedback in accordance with aspects of the present disclosure.

FIG. 10 shows a diagram of a system including a device that supports latency improvement via frame latency feedback in accordance with aspects of the present disclosure.

FIG. 11 illustrates a block diagram of a device that supports latency improvement via frame latency feedback in accordance with aspects of the present disclosure.

FIG. 12 shows a diagram of a system including a device that supports latency improvement via frame latency feedback in accordance with aspects of the present disclosure.

FIGS. 13 through 18 show flowcharts illustrating methods that support latency improvement via frame latency feedback in accordance with aspects of the present disclosure.

### DETAILED DESCRIPTION

For wireless display connections between a source device (e.g., a smartphone, laptop, tablet, etc.) and a sink device (e.g., a television, display, monitor, computer screen, etc.), end-to-end (e.g., glass to glass) latency is a key metric affecting user experience. For some applications (e.g., such as Real-time Transport Protocol (RTP) based applications including Miracast) network feedback mechanisms (e.g., Real-time Transport Control Protocol (RTCP)) may not provide latency information at the application level (e.g., network layer feedback mechanisms do not provide video frame latency statistics). Thus, there is no existing mechanism or framework to report and control complete frame latencies.

In accordance with aspects of the present disclosure, a sink device may determine and report end-to-end latency information representative of frame transmit time from the source device and frame display time of the sink device. The sink device may transmit a latency statistics report that includes aggregate frame network transmit latency metrics and aggregate frame end-to-end metrics categorized by frame sizes. For example, the sink device may receive several video frames varying in size, and may combine (e.g., aggregate) latency information associated with each video frame with other latency information corresponding to other video frames similar in size. According to the frame-based latency statistics, the source device may adjust media processing parameters (e.g., encoding bitrate, quantization parameters, frame resolution, etc.) so as to control end-to-end frame latencies to desired levels for different user experiences (e.g., the source may adjust media processing according to latency and picture quality trade-offs).

Aspects of the disclosure are initially described in the context of a wireless communications system. Example flowcharts and process flows implementing described techniques are then discussed. Aspects of the disclosure are further illustrated by and described with reference to apparatus diagrams, system diagrams, and flowcharts that relate to latency improvement via frame latency feedback

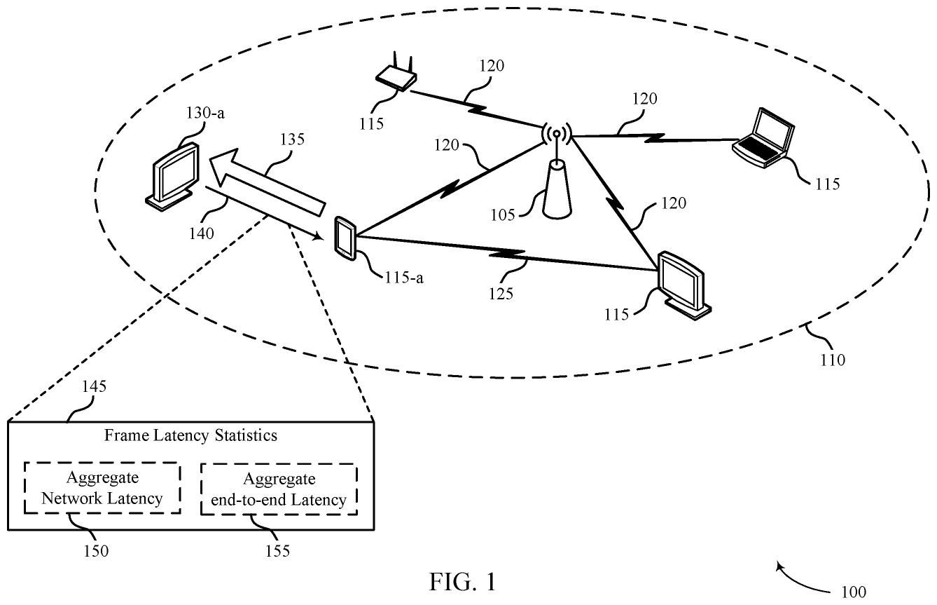

FIG. 1 illustrates a system 100 configured in accordance with various aspects of the present disclosure. System 100 may include a source device (e.g., STA 115-a) and a sink device (e.g., sink device 130-a), that may implement aspects of techniques described herein. For example, STA 115-a may transmit video frames of a video stream 135 to sink device 130-a. Sink device 130-a may transmit frame latency statistics 145 (e.g., associated with video frames of the video stream 135) to STA 115-a over link 140. The frame latency statistics 145 (e.g., a frame latency report) may include one or more aggregate latency metrics (e.g., aggregate latency metrics 150 and/or aggregate end-to-end latency metrics 155) categorized by video frame size. STA 115-a may adjust media processing (e.g., encoding bitrate, quantization parameters, frame resolution, etc.) of the video stream 135 based on the frame latency statistics 145, so as to control end-to-end frame latencies to desired levels for different user experiences (e.g., according to latency and picture quality trade-offs).

A STA 115-a may represent devices such as mobile stations, personal digital assistant (PDAs), other handheld devices, netbooks, notebook computers, tablet computers, laptops, etc. A sink device 130-a may represent display devices such as TVs, displays, screens, computer monitors, etc., or in some cases, may represent some other STA (e.g., the techniques described herein may be applicable to STAs 115 transmitting video streams to each other). As such, STA 115-a may represent a source device, which may refer to any device providing or transmitting multimedia content, such as a video stream, to a sink device for display. A sink device may refer to any device receiving and displaying multimedia content, such as a video stream, from a source device. A single device may act as a sink device in some examples and a source device in other examples.

In some cases, the system 100 may include aspects of or refer to a wireless local area network (WLAN) (also known as a Wi-Fi network). In such cases, the WLAN may include an AP 105 and multiple associated STAs 115, which may represent devices such as mobile stations, PDAs, other handheld devices, netbooks, notebook computers, tablet computers, laptops, display devices (e.g., TVs, computer monitors, etc.), printers, etc. In some examples, the AP 105 and the associated STAs 115 may represent a basic service set (BSS) or an extended service set (ESS). The various STAs 115 in the network may be able to communicate with one another through the AP 105. Also shown is a coverage area 110 of the AP 105, which may represent a basic service area (BSA) of the WLAN. An extended network station (not shown) associated with the WLAN may be connected to a wired or wireless distribution system that may allow multiple APs 105 to be connected in an ESS. In some cases, a video stream to be displayed on the sink device from the source device may originate or come from the WLAN (e.g., STA 115-a may receive a video stream or multimedia content from an AP 105, and may transmit the video stream or multimedia content for display at sink device 130-a). However, it should be noted that the techniques described herein may be employed regardless of whether or not the STA 115-a is connected to the WLAN (e.g., STA 115-a need not have any Wi-Fi connection to employ the described techniques).

In some cases (e.g., for Miracast), glass-to-glass latency may represent an important performance metric. The network layer may contribute a large part to the variance in frame transit times within video stream 135. In some cases, latency may be estimated by estimating bandwidth and network delay. In Miracast (e.g., and some other applications), frame latencies may be estimated from estimated bandwidth alone (e.g., because network delay may be negligible because of the peer-to-peer topology). However, bandwidth estimation from bursty traffic may not be reliable. Additionally, no framework exists through which a sink device may receive frame latency feedback and tightly control frame end-to-end latencies in Miracast applications (e.g., where frame latency may refer to the amount of time between when the first byte of data for a given frame is transmitted from a source device to when the last byte of data of the frame is received at a sink device).

Specifically, RTCP may not be suitable to provide frame latency statistics for Miracast. For example, RTCP does not provide insight into latency even with solely RTP packets. Thus, RTCP may not provide any latency insight at the video frame level. Further, RTCP jitter values are across consecutive RTP packets (e.g., not across frames). Similarly, RTCP statistics packet losses and jitter provide feedback at the RTP level. MPEG-2 transport streams (Mpeg2ts) or any other multimedia transmission framework may reside one layer above the RTP level. Additionally, frames transmitted over Mpeg2ts may be transmitted over a user datagram protocol (UDP) or transmit control protocol (TCP). Depending on the amount of error correction or recovery, frame transmit time on the network may increase (e.g., for UDP with NACK or forward error correction (FEC)).

As discussed above, sink device 130-a may provide frame latency statistics 145 including application level or frame level latency information to STA 115-a. Specifically, aspects of the present disclosure relate to collection of application-level (e.g., video frame) statistics and control of end-to-end latency based on this feedback. In some cases, the proposed framework may be implemented at the Mpeg2ts level (e.g., as complete frame sizes are known at this level). Frame latencies may also depend on the transport type. For example, frame latencies may be lower with plain UDP (e.g., at the expense of packet loss) but may be larger when FEC or NACK schemes are used for UDP and when TCP is used (e.g., which may automatically correct for packet loss).

Frame latency statistics 145 may include an aggregate report of frame latency categorized by aggregate frame sizes. An example reporting statistics format is shown below in Table 1. As shown, aggregate network latency metrics 150 and/or aggregate end-to-end latency metrics 155 may be included in the reporting statistics, and these metrics may be categorized according to frame size. Such techniques may support control (e.g., tight control) of end-to-end latency for Miracast applications.

TABLE 1

| | | Aggregate | Aggregate |
|---|---|---|---|
| | | Network | End-to-End |
| Bucket ID | Aggregate Frame Size | Latency | Latency |
| 0 | Size < 10 MP | 0.5 ms | 1.2 ms |
| 1 | 10 MP < Size < 20 MP | 0.3 ms | 1.7 ms |
| . | | | |
| . | | | |
| . | | | |
| N | 100 MP < Size | 1.5 ms | 2.1 ms |

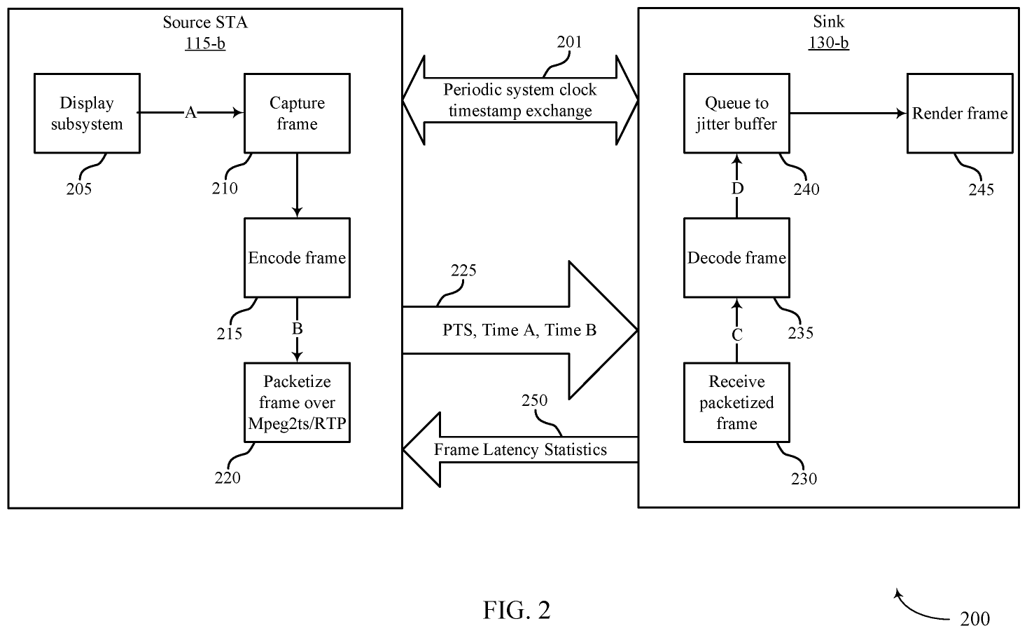

FIG. 2 illustrates an example of a process flow 200 that supports latency improvement via frame latency feedback in accordance with aspects of the present disclosure. In some examples, process flow 200 may implement aspects of system 100. Process flow 200 includes source STA 115-b and sink device 130-b, which may be examples STAs and sink devices as described with reference to FIG. 1. Process flow 200 may illustrate a source device (e.g., source STA 115-b) adjusting media processing parameters for a video stream based on frame latency statistics from sink device 130-b. In the following description of the process flow 200, the operations between the source STA 115-b and the sink device 130-b may be transmitted in a different order than the exemplary order shown, or the operations performed by source STA 115-b and sink device 130-b a may be performed in different orders or at different times. In some cases, certain operations may also be left out of the process flow 200, or other operations may be added to the process flow 200.

At source STA 115-b, display subsystem 205 may control display at source STA 115-b (e.g., display subsystem 205 may include a display or screen, as well as a display processing module controlling the display) and may further control transmission of a frame to sink device 130-b (e.g., for display to display connections). For example, at 210 source STA 115-b may capture a frame at time A (e.g., may record a frame, may receive a frame from another device, may retrieve a frame from memory, etc.). In some cases, at 210, source STA 115-b may note time A, which may be referred to as a frame capture time. At 215, source STA 115-b may encode the frame (e.g., according to a given bitrate), and at 220 source STA 115-b may packetize the frame for transmission over Mpeg2ts (e.g., or RTP), which transmission may begin at time B. In some cases, source STA 115-b may note time B, which may be referred to as a frame transmit start time. In accordance with aspects of the present disclosure, source STA 115-b and sink device 130-b may exchange periodic system clock timestamps at 201. For example, the exchange of periodic system clock timestamps may allow source STA 115-b and sink device 130-b to be synchronized to a common clock (e.g., with an accuracy of 2-3 ms).

At 225 (e.g., at time B), source STA 115-b may transmit a frame over Mpeg2ts (e.g., or RTP) to sink device 130-b. For example, the frame may be transmitted over Mpeg2ts (e.g., private-stream-1 may be used by Miracast for content protection). The frame may, for example, contain or be associated with a PTS, a frame capture time (e.g., time A), and a frame transmit start time (e.g., time B). For example, at 225, source STA 115-b may transmit a frame with a video PID, the frame (e.g., video frame) may be multiplexed together with PTS, frame capture time, and frame transmit time (e.g., which may be sent over mpeg2ts private stream 2), where the PID may indicate what the stream represents.

At 230, sink device 130-b may receive the packetized frame (e.g., or portions thereof). At 235, sink device 130-b may decode the frame. At 240, sink device 130-b may add the decoded frame to a queue for a jitter buffer. At 245, sink device 130-b may render the frame. Sink device 130-b may note a frame receive time C (e.g., a time when the entire frame is received) as well as a frame render time D (e.g., a time when the frame is sent to a jitter buffer), and a size of the received frame. Sink device 130-b may calculate a network transmit time for the frame (e.g., C-B) as well as an end-to-end time for the frame (e.g., D-A) using the common clock (e.g., provided by 201).

Sink device 130-b may store entries corresponding to a given reporting duration, where each entry includes frame size, frame network transit time, and a frame end-to-end transit time. For example, the reporting duration may correspond to a multiple of a picture group (e.g., group of pictures) duration plus a small delta (e.g., so that approximately the same number of frames may be included in each reporting duration). For example, a GOP may include one reference frame followed by a number of picture frames (P-frames) or B-frames. The size of the reference frame may be larger than the size of the frames that follow within a GOP. In cases where the reporting duration is based on a multiple of the GOP size (e.g., n*max_GOP_interval_size+small delta, n>0), statistics of a relatively similar number of large frames and small frames may be included in each statistics report from sink device 130-b.

At regular intervals (e.g., reporting intervals) represented by at 250, sink device 130-b may send frame latency statistics to source STA 115-b (e.g., via Real Time Streaming Protocol (RTSP) SET_PARAMETER). In some examples, the reporting interval duration is longer than the reporting duration. The frame latency statistics may include an aggregate report of frame latency metrics categorized by aggregate frame sizes (e.g., as illustrated with respect to Table 1). Sink device 130-b may provide feedback to source STA 115-b via RTSP SET_PARAMETER, where the feedback includes the frame network latency statistics categorized by frame sizes at regular reporting intervals.

In some examples, the path between source STA 115-b and sink device 130-b (e.g., from time A to time D) may be designed to add minimal (e.g., zero) delay. For example, additional latencies may be due to Mpeg2ts timing requirements or a file format where a media sample (e.g., access unit) may not be available for use at sink device 130-b unless the start of the next sample arrives (or the end of the stream is reached). A deployment to exclude (e.g., or minimize) the delays imposed by such design constraints may be desired.

Source STA 115-b may receive the frame latency statistics (e.g., at every interval corresponding to 250), and may gauge and react to user quality of experience based on the latency metric. For example, source STA 115-b may compute an aggregate latency as a weighted sum of the latency values across categories. For example, the aggregate latency L may be calculated as L=Σᵢ₌₀ⁿ⁻¹ w(i)*l(i) where Σᵢ₌₀ⁿ⁻¹w(i) and 0≤w(i)≤1. In this equation, l(i) may represent the aggregate latency for frame size category c(i). For example, the sink device 130-b may receive several frames varying in size, and may categorize latency information associated with each frame into one or more c(i) categories (e.g., where each c(i) corresponds to some frame size or range of frame sizes). The latency information (e.g., frame network transmit latency metrics and/or frame end-to-end latency metrics) within each c(i) may be combined (e.g., aggregated). Aggregate latency information l(i) may thus refer to an aggregate frame network transmit latency metric, an aggregate frame end-to-end latency metric, or some weighted combination of both, corresponding to a c(i). As such, aggregate latency information l(i) may be weighted according to different weighting w(i) corresponding to the c(i) associated with the l(i) (e.g., a w(i) may weight or prioritize aggregate latency information by frame size).

Source STA 115-b may compare L to a threshold target network latency T. For example, T may represent a configurable threshold, a static threshold, a dynamically determined threshold, or the like. Source STA 115-b may decrease, increase, or maintain a current bitrate (e.g., or other such parameter) based on the comparison. Additionally, or alternatively, source STA 115-b may modify quantization parameters and/or a frame resolution based at least in part on the comparison. A larger weight for categories corresponding to larger frame sizes may result in more aggressive behavior on latency (e.g., where aggressive may refer to prioritizing latency minimization over picture quality). Smaller values of T may also result in more aggressive behavior on latency.

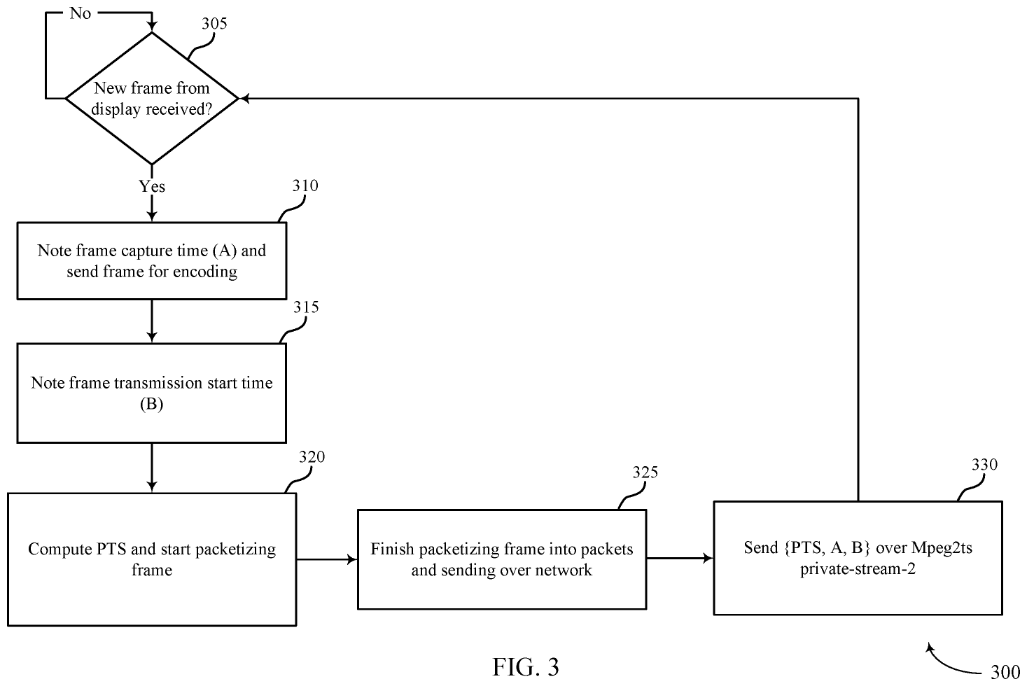

FIG. 3 illustrates an example of a flowchart 300 that supports latency improvement via frame latency feedback in accordance with aspects of the present disclosure. In some examples, flowchart 300 may implement aspects of system 100. For example, flowchart 300 may illustrate aspects of operations of a source device as described with reference to FIGS. 1 and 2. Aspects of the operations described with reference to flowchart 300 may be rearranged, supplemented, or otherwise adjusted without deviating from the scope of the present disclosure. Flowchart 300 may illustrate transmission of frame auxiliary data (e.g., PTS, frame capture time, frame transmit start time, etc.) from a source device to a sink device. In the following description, it may be assumed that the source device and sink device a synchronized to a common clock (e.g., both synchronized to the source device system clock).

At 305, the source device may determine whether a new frame has been received. If a new frame is received, the source device may note the frame capture time (A) at 310 and send the frame for encoding. At 315, the source device may note that the encoded frame is ready for transmission and may note the frame transmission start time (B). At 320, the source device may compute PTS for the frame and start packetizing the frame (e.g., with a video packet identifier (PID) over RTP) and sending the frame over the network. At 325, the source device may finish packetizing the frame into RTP packets and sending them over the network. At 330, the source device may transmit an indication of the PTS, the frame capture time A, and the frame transmission start time B over Mpeg2ts private-stream-2.

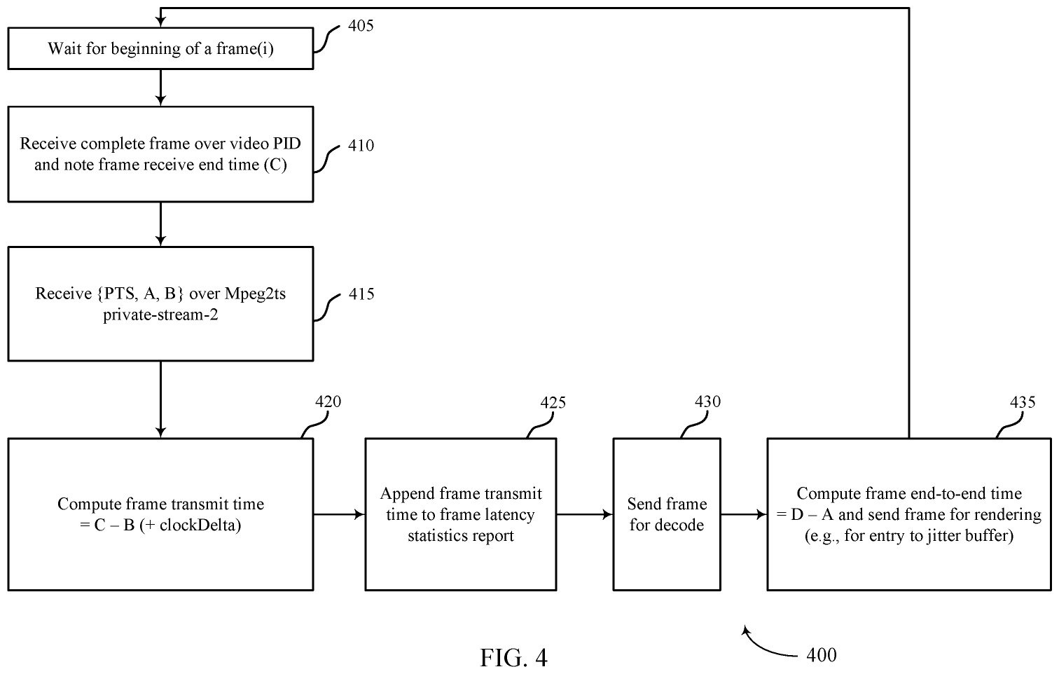

FIG. 4 illustrates an example of a flowchart 400 that supports latency improvement via frame latency feedback in accordance with aspects of the present disclosure. In some examples, flowchart 400 may implement aspects of system 100. For example, flowchart 400 may illustrate aspects of operations of a sink device as described with reference to FIGS. 1 and 2. Aspects of the operations described with reference to flowchart 400 may be rearranged, supplemented, or otherwise adjusted without deviating from the scope of the present disclosure. Flowchart 400 may illustrate receipt of frame auxiliary data (e.g., PTS, frame capture time, frame transmit start time, etc.) at a sink device. In the following description, it may be assumed that the source device and sink device a synchronized to a common clock (e.g., both synchronized to the source device system clock).

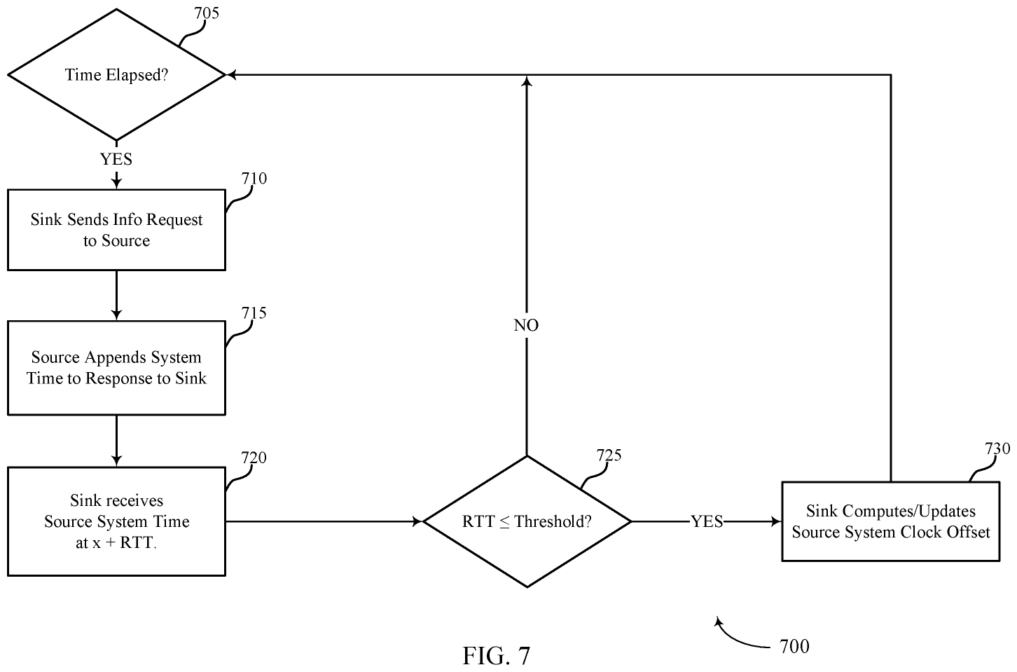

At 405, the sink device may wait for the beginning of a frame (e.g., may monitor for the first bytes of the frame). At 410, the sink device may finish receiving the frame corresponding to a video PID and note the frame receive end time C. At 415, the sink device may receive an indication of the PTS, the frame capture time A, and the frame transmission start time B over Mpeg2ts private-stream-2. At 420, the sink device may compute a frame transmit time as C-B (e.g., plus any clock delta which may be determined as described with reference to FIG. 7). At 425, the sink device may append the frame transmit time to a frame latency statistics report. At 430, the sink device may send the frame for decoding. At 435, the sink device may send the frame to a jitter buffer (e.g., may submit the frame for rendering) and may note the frame render time D (e.g., the current time at which the frame is sent to the jitter buffer). The sink device may compute the frame end-to-end time as D-A (e.g., using the common clock as discussed with reference to FIG. 7).

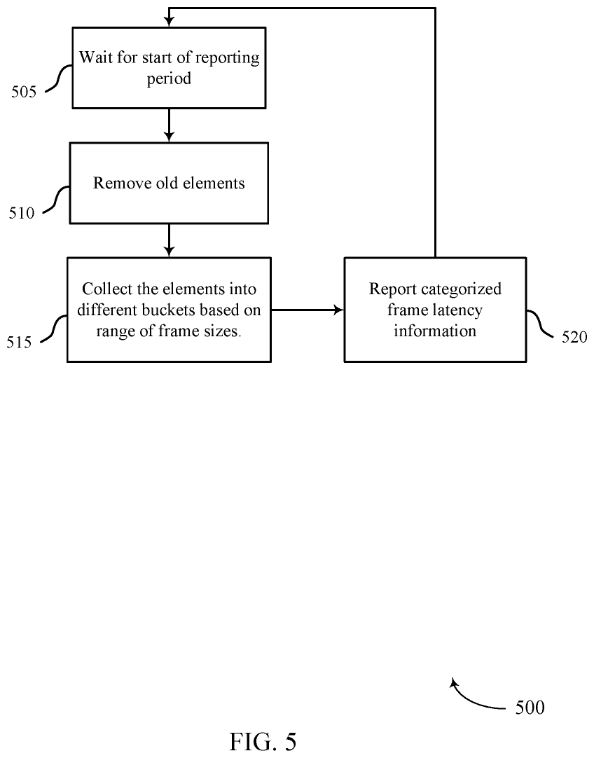

FIG. 5 illustrates an example of a flowchart 500 that supports latency improvement via frame latency feedback in accordance with aspects of the present disclosure. In some examples, flowchart 500 may implement aspects of system 100. For example, flowchart 500 may illustrate aspects of operations of a sink device as described with reference to FIGS. 1 and 2. Aspects of the operations described with reference to flowchart 500 may be rearranged, supplemented, or otherwise adjusted without deviating from the scope of the present disclosure. Flowchart 500 may illustrate determination or construction of frame latency statistics (e.g., a frame latency report including aggregate frame network transmit latency metrics and aggregate frame end-to-end metrics) at a sink device. In the following description, it may be assumed that the source device and sink device a synchronized to a common clock (e.g., both synchronized to the source device system clock).

At 505, the sink device may wait for the start of a reporting period (e.g., which may occur every 10 ms, every 100 ms, etc.). At 510, the sink device may remove any elements from a frame transmit time list that are older than the current reporting duration (e.g., corresponding to the current reporting period). For example, each element may include a frame size, a frame transmit time (e.g., C-B), and a frame end-to-end time (e.g., D-A) as described with reference to Table 1. At 515, the sink device may categorize the elements into different buckets (e.g., based on frame size). For example, a first bucket may contain the first 95% of the elements (e.g., corresponding to the smaller frame sizes) while a second bucket may contain the other 5% of elements (e.g., corresponding to the larger frame sizes). At 520, the sink device may report the categorized frame latency information. For example, the sink device may compute an average frame transmit time for each bucket and may send an RTSP_SET_PARAMETER message including the frame latency information to a source device.

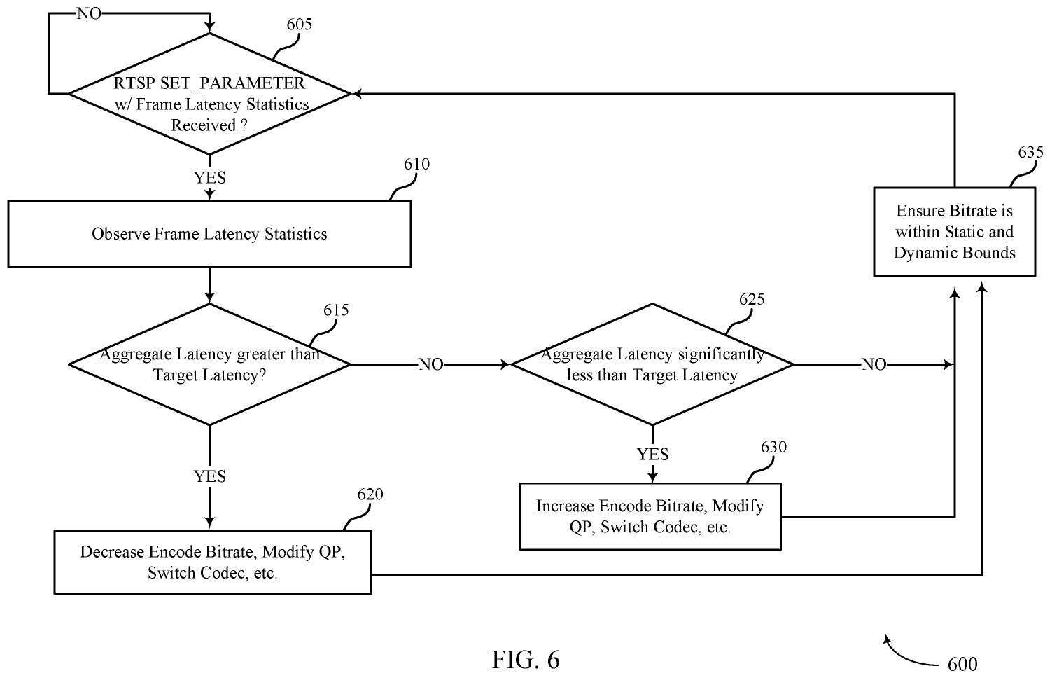

FIG. 6 illustrates an example of a flowchart 600 that supports latency improvement via frame latency feedback in accordance with aspects of the present disclosure. In some examples, flowchart 600 may implement aspects of system 100. For example, flowchart 600 may illustrate aspects of operations of a source device as described with reference to FIGS. 1 and 2. Aspects of the operations described with reference to flowchart 600 may be rearranged, supplemented, or otherwise adjusted without deviating from the scope of the present disclosure. Flowchart 600 may illustrate latency control (e.g., media processing adjustments) at a source device. In the following description, it may be assumed that the source device and sink device a synchronized to a common clock (e.g., both synchronized to the source device system clock).

At 605, a source device may determine or identify whether a RTSP parameter with frame latency statistics (e.g., a frame latency report) has been received. In cases where the source device identifies a RTSP parameter with frame latency statistics (e.g., received from a sink device), the source device may observe the frame latency statistics at 610. For example, at 610, the source device my compute the aggregate latency as the weighted sum of the aggregate latencies across the different categories (e.g., aggregate latency L may be calculated at 610).

At 615, the source device may compare the aggregate latency L to a target network latency T. In cases where the aggregate latency is greater than the target network latency (e.g., L>7), the source device may decrease encode bitrate, modify the QPs or resolution, switch to a codec associated with lower bandwidth requirements (e.g., high-efficiency video coding (HEVC)), or some combination thereof, at 620. In cases where the aggregate latency is less than the target network latency (e.g., L<T), the source device may determine whether the aggregate latency is significantly less than the target network latency, at 625. For example, the source device may determine whether L<T−threshold. At 630, if the aggregate latency is less than the target network latency by more than some threshold, the source device may increase the encode bitrate, modify the QPs, switch to a codec associated with higher bandwidth requirements, etc. (e.g., as more aggressive media processing, or increased data rates, may be achievable while still meeting target latency requirements). In all cases (e.g., whether the media processing is adjusted at 620 or 630, or if the media processing is not adjusted), the source device may ensure the bitrate is within static and dynamic bounds at 635.

FIG. 7 illustrates an example of a flowchart 700 that supports latency improvement via frame latency feedback in accordance with aspects of the present disclosure. In some examples, flowchart 700 may implement aspects of system 100. Flowchart 700 may illustrate a source device and sink device synchronizing to a common clock in accordance with aspects of the present disclosure. In the following description of the flowchart 700, the operations between the source device and the sink device may be transmitted in a different order than the exemplary order shown, or the operations performed by the source device and the sink device a may be performed in different orders or at different times. In some cases, certain operations may also be left out of flowchart 700, or other operations may be added to flowchart 700.

At 705, if some time duration has elapsed (e.g., if some random wait time or synchronization duration has elapsed), a sink device may send an information request (e.g., {SinkSystemTime=x}) to a source device at 710. At 715, a source device may append the source system time (e.g., according to a clock of the source device) to a response to the sink device. For example, the source device may append {SinkSystemTime=x, SourceSystemTime=y} and send a response to the sink device. At 720, the sink device may receive {SinkSystemTime=x, SourceSystemTime=y} at some time x+RTT (e.g., the sink may receive the source system time at some time x+the round trip time associated with the request transmitted by the sink and the response transmitted by the source. At 725, if the round trip time (RTT) is less than or equal to some RTT threshold (e.g., RTT≤RTT_{threshold}), the sink device may, at 730, compute and, in some cases, update the source system clock offset (e.g., systemClockDelta) with respect to the sink system time. Such may account for clock drift between the source device and the sink device.

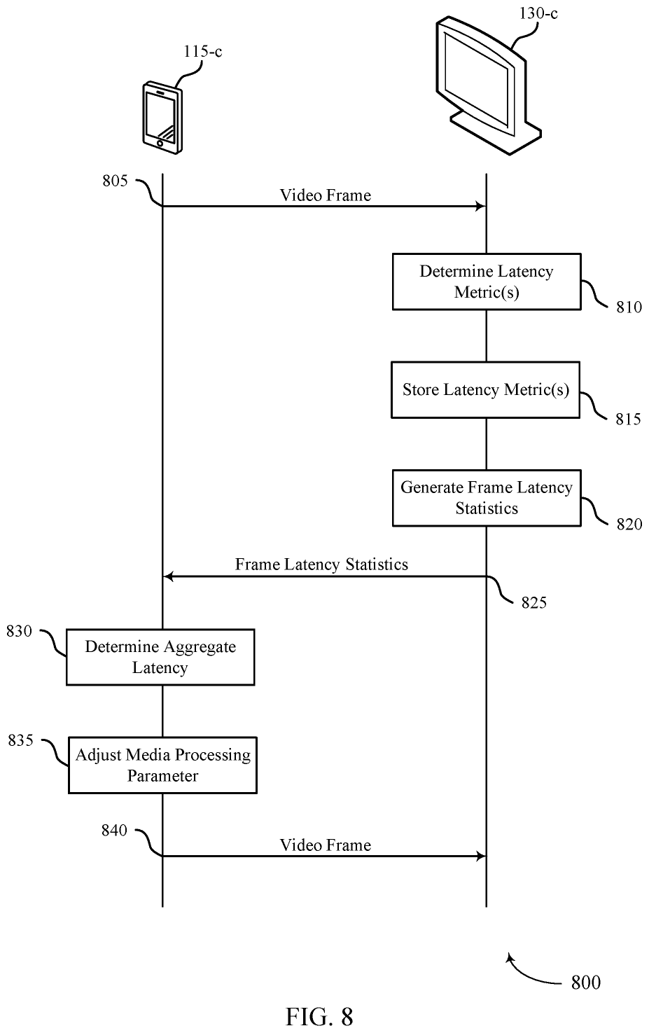

FIG. 8 illustrates an example of a process flow 800 that supports latency improvement via frame latency feedback in accordance with aspects of the present disclosure. In some examples, process flow 800 may implement aspects of system 100. Process flow 800 includes STA 115-c and sink device 130-c, which may be examples STAs and sink devices as described with reference to FIGS. 1-7. Process flow 800 may illustrate a source device (e.g., STA 115-c) adjusting media processing parameters for a video stream based on frame latency statistics from sink device 130-c. In the following description of the process flow 800, the operations between the STA 115-c and the sink device 130-c may be transmitted in a different order than the exemplary order shown, or the operations performed by STA 115-c and sink device 130-c a may be performed in different orders or at different times. In some cases, certain operations may also be left out of the process flow 800, or other operations may be added to the process flow 800.

At 805, STA 115-c (e.g., a source device) may transmit a video frame (e.g., of a video stream) over a communication link to a sink device 130-c. In some cases, the video frame may correspond to a PTS frame that includes a frame capture time and a frame transmit start time associated with the video frame.

At 810, sink device 130-c may determine a latency metric for the video frame based on the PTS frame (e.g., the corresponding PTS frame) and the size of the video frame. For example, the sink device 130-c may determine a latency metric for the video frame, and may associate the latency metric with a bucket or category that corresponds to the size of the video frame. The latency metric may include or refer to a frame network transmit time or a frame end-to-end time. In some cases, the sink device 130-c may determine both a frame network transmit time and a frame end-to-end time associated with the video frame received at 805 (e.g., the sink device 130-c may determine two latency metrics for the video frame).

When receiving the video frame, the sink device 130-c may note the frame receive time as well as the frame render time (e.g., the frame render time based on decoding the video frame). The frame receive time and the frame render time, in addition to the frame capture time and a frame transmit start time (e.g., included in the PTS frame corresponding to the video frame) may be used to determine one or both of the latency metrics associated with the video frame, as described with reference to FIG. 2. For example, the sink device 130-c may determine a frame network transmit time latency metric by subtracting the frame transmit start time from the frame receive time. Additionally, or alternatively, the sink device 130-c may determine a frame end-to-end time latency metric by subtracting the frame capture time from the frame render time.

At 815, sink device 130-c may store the latency metric for a reporting duration. In some cases, the sink device 130-c may reduce the reporting duration based on a frame latency metric. For example, if a frame latency metric indicates undesirable or critical latency, the sink device 130-c may reduce the reporting duration to generate and transmit frame latency statistics to the STA 115-c earlier. In some cases, the reporting duration may be reduced when a determined latency metric exceeds some threshold (e.g., indicating the video frame latency calls for faster frame latency statistics reporting). In some examples, operations or procedures 805-815 may repeat for additional video frames of the video stream until the reporting duration expires. For example, the sink device 130-c may receive video frames, determine latency metrics for the video frames, and store the latency metrics for the reporting duration. The sink device 130-c may then generate frame latency statistics based on the stored latency metrics upon expiration of the reporting duration, as described below.

At 820, sink device 130-c may generate frame latency statistics (e.g., based on the latency metrics stored for the reporting duration). For example, sink device 130-c may generate an aggregate network latency metric for one or more categories (e.g., frame size buckets) by combining frame network transmit times for video frames received having a same or similar size. Additionally, or alternatively, sink device 130-c may generate an aggregate end-to-end latency metric for the one or more categories by combining frame end-to-end times for video frames received having a same or similar size. That is, sink device 130-c may receive one or more video frames (e.g., of a video stream), and may categorize the received video frames according to their size. For each category, sink device 130-c may generate one or more aggregate latency metrics (e.g., an aggregate network latency metric and/or an aggregate end-to-end latency metric) by combining the latency metrics associated with each category.

At 825, sink device 130-c may transmit frame latency statistics (e.g., a frame latency report) to STA 115-c. The frame latency statistics may include aggregate network latency metrics, aggregate end-to-end latency metrics, or both, categorized by frame size.

At 830, STA 115-c may determine an aggregate latency (an aggregate latency for the video stream) based on the frame latency statistics received at 825. In some cases, the aggregate latency may be determined based on the aggregate network latency metrics, aggregate end-to-end latency metrics, or both. For example, the aggregate latency may be determined according to some weighted combination of the aggregate network latency metrics, some weighted combination of the aggregate end-to-end latency metrics, or some weighted combination of both aggregate network latency metrics and aggregate end-to-end latency metrics. In some cases, the weighting may be based on the category or frame size associated with the latency metric (e.g., an aggregate network latency metric or an aggregate end-to-end latency metric may be associated with a weighting coefficient that is based on the category or frame size corresponding to the latency metric). In some cases, the weighting (e.g., the weighting coefficients) for the different categories may be based on a target latency associated with the video stream.

At 835, STA 115-c may adjust one or more media processing parameters for the video stream based on a comparison of (e.g., a difference between) a target latency threshold and the aggregate latency determined at 830. In some cases, the target latency threshold may be associated with operational needs of the video stream (e.g., such as block error rate (BLER), latency constraints, video quality considerations, etc.). The media processing parameters that may be adjusted may include an encoding bitrate for the video stream, a quantization parameter for the video stream, a frame resolution parameter for the video stream, etc. Adjustments of such parameters may allow for video stream adjustments (e.g., reduced video frame latency, improved picture quality, etc.) according to system implementation of target latency thresholds, reporting duration configuration, etc.

At 840, STA 115-c may transmit one or more video frames over a communication link to sink device 130-c according to the adjusted media processing parameters.

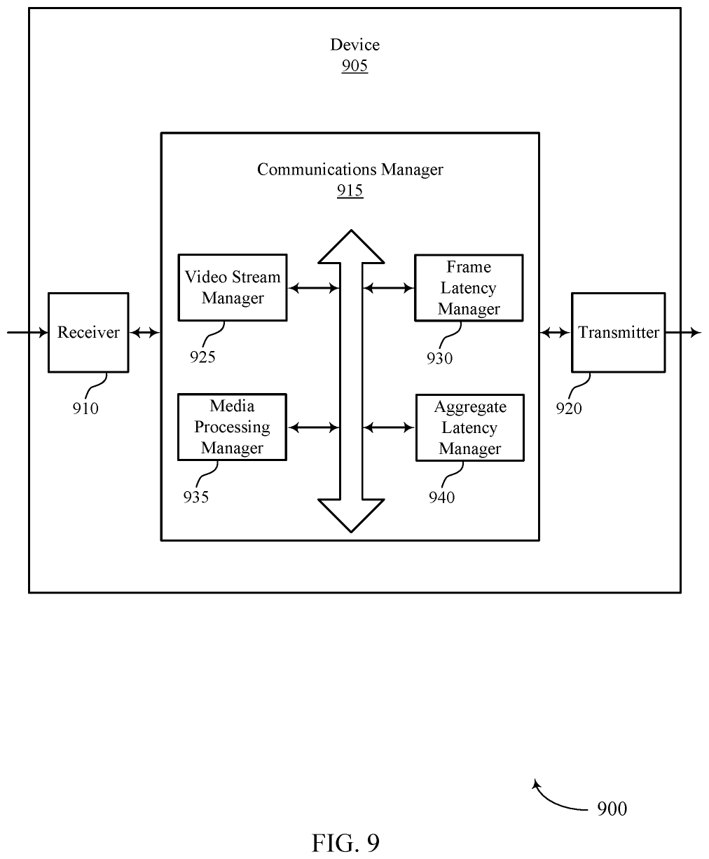

FIG. 9 shows a block diagram 900 of a device 905 that supports latency improvement via frame latency feedback in accordance with aspects of the present disclosure. The device 905 may be an example of aspects of a STA 115 as described herein. The device 905 may include a receiver 910, a communications manager 915, and a transmitter 920. The device 905 may also include a processor. Each of these components may be in communication with one another (e.g., via one or more buses).

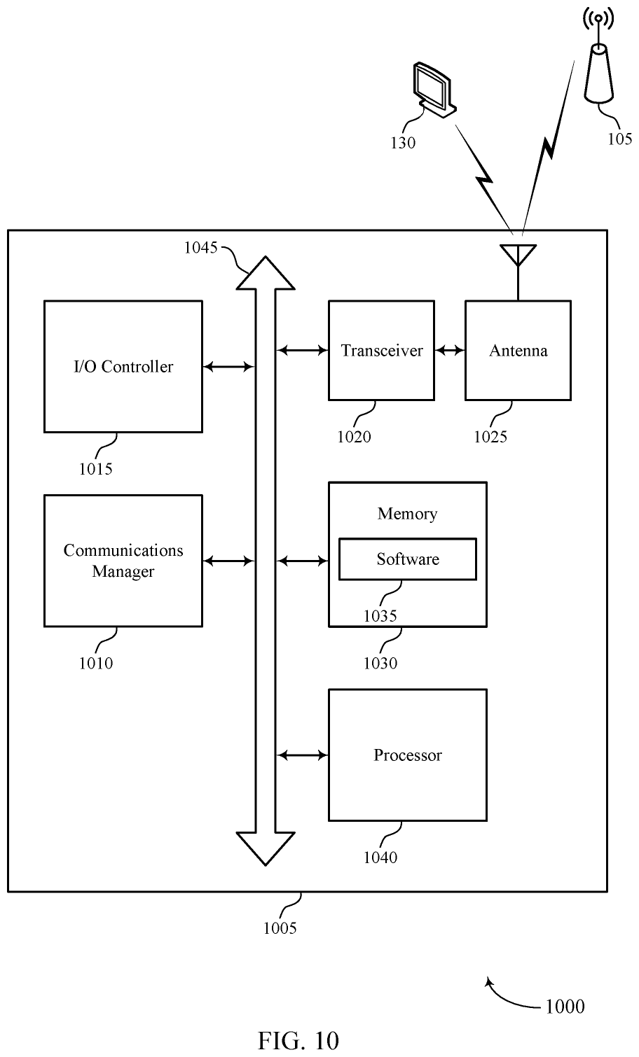

The receiver 910 may receive information such as packets, user data, or control information associated with various information channels (e.g., control channels, data channels, and information related to latency improvement via frame latency feedback, etc.). Information may be passed on to other components of the device 905. The receiver 910 may be an example of aspects of the transceiver 1020 described with reference to FIG. 10. The receiver 910 may utilize a single antenna or a set of antennas.

The communications manager 915 may transmit video frames of a video stream over a communication link to a sink device, where each video frame corresponds to a PTS frame including a frame capture time and a frame transmit start time associated with the corresponding video frame. The communications manager 915 may receive frame latency statistics from the sink device, the frame latency statistics based on the video frames and the corresponding PTS frames. The communications manager 915 may adjust at least one media processing parameter for the video stream based on a difference between an aggregate latency for the video frames and a latency threshold, where the aggregate latency is based on the frame latency statistics. The communications manager 915 may be an example of aspects of the communications manager 1010 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

In some cases, the communications manager 915 may include subcomponents such as a video stream manager 925, a frame latency manager 930, a media processing manager 935, and an aggregate latency manager 940. The communications manager 915 may be an example of aspects of the communications manager 1010 described herein.

The video stream manager 925 may transmit video frames of a video stream over a communication link to a sink device, where each video frame corresponds to a PTS frame including a frame capture time and a frame transmit start time associated with the corresponding video frame.

The frame latency manager 930 may receive frame latency statistics from the sink device, the frame latency statistics based on the video frames and the corresponding PTS frames. In some examples, the frame latency manager 930 may identify a set of aggregate frame latency metrics based on the frame latency statistics, where each aggregate frame latency metric is associated with a respective video frame size.

The media processing manager 935 may adjust at least one media processing parameter for the video stream based on a difference between an aggregate latency for the video frames and a latency threshold, where the aggregate latency is based on the frame latency statistics. In some examples, the media processing manager 935 may adjust one or more of an encoding bitrate for the video stream, a quantization parameter for the video stream, a frame resolution parameter for the video stream, or a combination thereof.

The aggregate latency manager 940 may weight each of the aggregate frame latency metrics using a respective weighting coefficient, where each weighting coefficient is based on the respective video frame size. In some examples, the aggregate latency manager 940 may determine the aggregate latency by accumulating the weighted aggregate frame latency metrics. In some cases, at least one weighting coefficient, or the latency threshold, or a combination thereof is based on a target latency associated with the video stream. In some cases, an aggregate network latency metric, an aggregate end-to-end metric, or some combination thereof.

The transmitter 920 may transmit signals generated by other components of the device 905. In some examples, the transmitter 920 may be collocated with a receiver 910 in a transceiver module. For example, the transmitter 920 may be an example of aspects of the transceiver 1020 described with reference to FIG. 10. The transmitter 920 may utilize a single antenna or a set of antennas.

FIG. 10 shows a diagram of a system 1000 including a device 1005 that supports latency improvement via frame latency feedback in accordance with aspects of the present disclosure. The device 1005 may be an example of or include the components of device 905 or a STA 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may transmit video frames of a video stream over a communication link to a sink device, where each video frame corresponds to a PTS frame including a frame capture time and a frame transmit start time associated with the corresponding video frame. The communications manager 1010 receive frame latency statistics from the sink device, the frame latency statistics based on the video frames and the corresponding PTS frames. The communications manager 1010 may adjust at least one media processing parameter for the video stream based on a difference between an aggregate latency for the video frames and a latency threshold, where the aggregate latency is based on the frame latency statistics.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include RAM and ROM. The memory 1030 may store computer-readable, computer-executable software 1035 including instructions that, when executed, cause the processor to perform various functions described herein. In some cases, the memory 1030 may contain, among other things, a BIOS which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting latency improvement via frame latency feedback).

The software 1035 may include instructions to implement aspects of the present disclosure, including instructions to support wireless communication. The software 1035 may be stored in a non-transitory computer-readable medium such as system memory or other type of memory. In some cases, the software 1035 may not be directly executable by the processor 1040 but may cause a computer (e.g., when compiled and executed) to perform functions described herein.

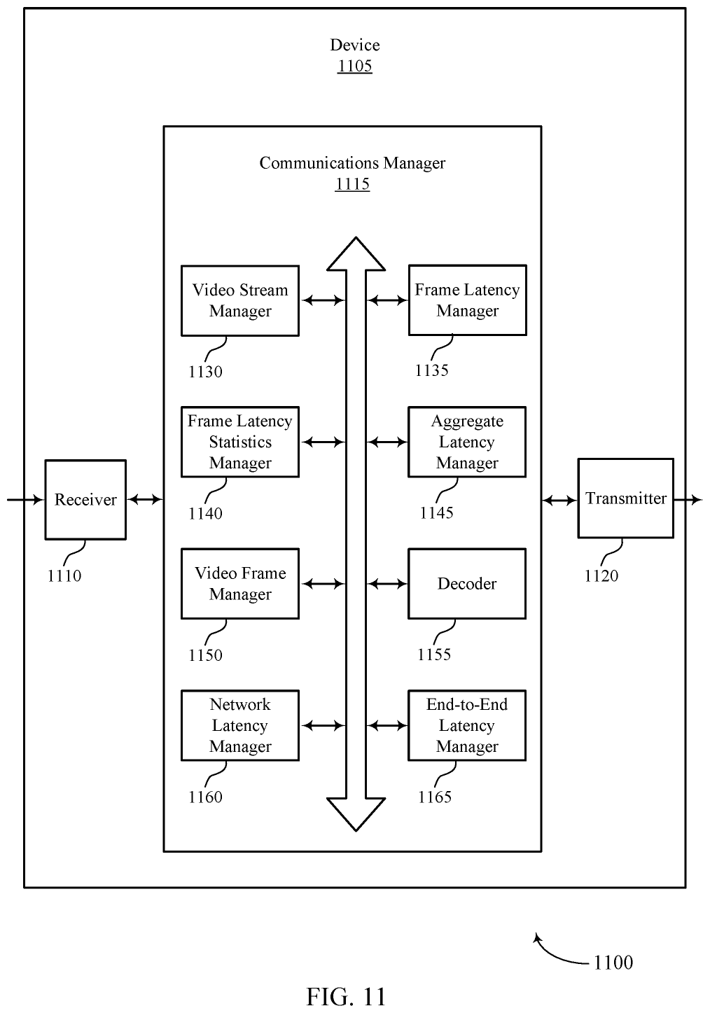

FIG. 11 shows a block diagram 1100 of a device 1105 that supports latency improvement via frame latency feedback in accordance with aspects of the present disclosure. The device 1105 may be an example of aspects of a device as described herein. The device 1105 may include a receiver 1110, a communications manager 1115, and a transmitter 1120. The device 1105 may also include a processor. Each of these components may be in communication with one another (e.g., via one or more buses).

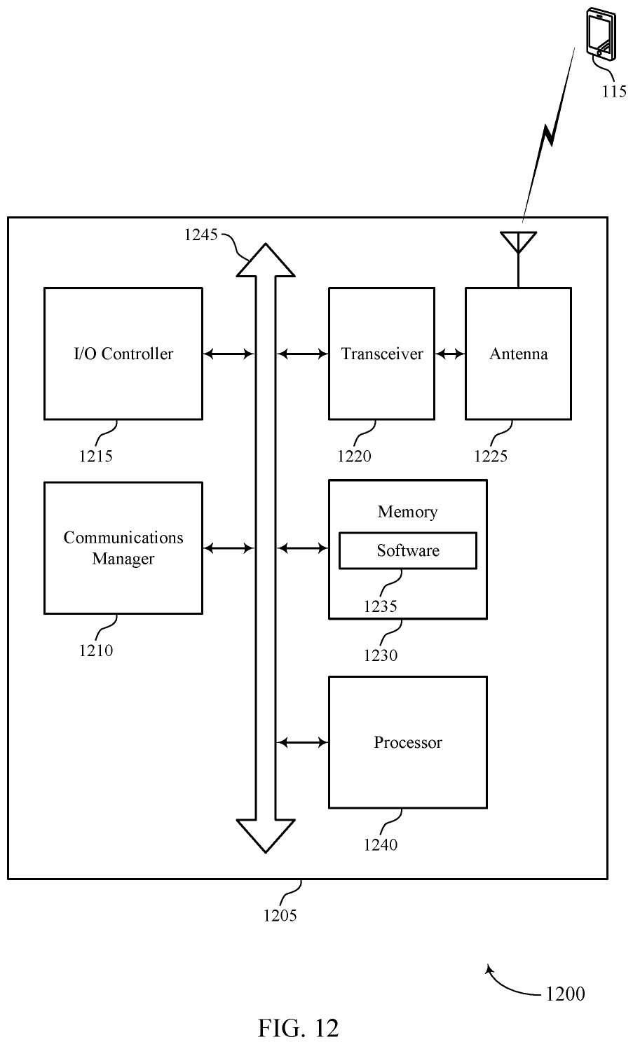

The receiver 1110 may receive information such as packets, user data, or control information associated with various information channels (e.g., control channels, data channels, and information related to latency improvement via frame latency feedback, etc.). Information may be passed on to other components of the device 1105. The receiver 1110 may be an example of aspects of the transceiver 1220 described with reference to FIG. 12. The receiver 1110 may utilize a single antenna or a set of antennas.

The communications manager 1115 may receive a video frame and a PTS frame from a source device, where the PTS frame includes a frame capture time and a frame transmit start time associated with the video frame. The communications manager 1115 transmit the frame latency statistics to the source device, determine a latency metric for the video frame based on the PTS frame and a size of the video frame. The communications manager 1115 generate frame latency statistics including frame latency information categorized by frame size into one or more categories, where a portion of the frame latency information associated with one of the categories is based on the latency metric for the video frame. The communications manager 1115 may be an example of aspects of the communications manager 1210 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The communications manager 1115 may include sub-components such as a video stream manager 1130, a frame latency manager 1135, a frame latency statistics manager 1140, an aggregate latency manager 1145, a video frame manager 1150, a decoder 1155, a network latency manager 1160, and an end-to-end latency manager 1165. The communications manager 1115 may be an example of aspects of the communications manager 1210 described herein.

The video stream manager 1130 may receive a video frame and a PTS frame from a source device, where the PTS frame includes a frame capture time and a frame transmit start time associated with the video frame. In some examples, the video stream manager 1130 may transmit the frame latency statistics to the source device.

The frame latency manager 1135 may determine a latency metric for the video frame based on the PTS frame and a size of the video frame.

The frame latency statistics manager 1140 may generate frame latency statistics including frame latency information categorized by frame size into one or more categories, where a portion of the frame latency information associated with one of the categories is based on the latency metric for the video frame. In some examples, the frame latency statistics manager 1140 may generate the frame latency statistics based on the stored frame latency metric and the reporting duration. In some cases, the frame latency information categorized by frame size into one or more categories includes one or more aggregate frame latency metrics categorized by frame size into the one or more categories, one or more aggregate network latency metrics categorized by frame size into the one or more categories, or some combination thereof.

The aggregate latency manager 1145 may generate an aggregate frame latency metric for the one of the categories by combining the latency metric for the video frame with one or more other latency metrics, where each of the other latency metrics is based on another video frame having a same size as the size of the video frame. In some examples, the aggregate latency manager 1145 may store the frame latency metric for a reporting duration. In some examples, the aggregate latency manager 1145 may reduce the reporting duration based on the frame latency metric, where the frame latency statistics are generated based on the reduced reporting duration. In some examples, the aggregate latency manager 1145 may combine respective latency metrics for each of a set of frame sizes. In some examples, the aggregate latency manager 1145 may generate an aggregate frame latency metric for each of the frame sizes based on the combining, where the frame latency statistics include the aggregate frame latency metrics categorized by their respective frame size.

The video frame manager 1150 may identify a frame receive time based on the video frame or the PTS frame. The decoder 1155 may decode the video frame. In some examples, the video frame manager 1150 may identify a frame render time based on the decoding.

The network latency manager 1160 may determine the frame network transmit time based on the frame transmit start time and the frame receive time. In some examples, the network latency manager 1160 may generate the aggregate network latency metric for the one of the categories by combining the frame network transmit time for the video frame with one or more other frame network transmit times, where each of the other frame network transmit times is based on another video frame having a same size as the size of the video frame.

The end-to-end latency manager 1165 may determine the frame end-to-end time based on the frame capture time and the frame render time. In some examples, the end-to-end latency manager 1165 may generate the aggregate end-to-end latency metric for the one of the categories by combining the frame end-to-end time for the video frame with one or more other frame end-to-end times, where each of the other frame end-to-end times is based on another video frame having a same size as the size of the video frame.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1220 described with reference to FIG. 12. The transmitter 1120 may utilize a single antenna or a set of antennas.

FIG. 12 shows a diagram of a system 1200 including a device 1205 that supports latency improvement via frame latency feedback in accordance with aspects of the present disclosure. The device 1205 may be an example of or include the components of device 1105, device or a STA 115 as described herein. The device 1205 may include components for bi-directional voice and data communications including components for transmitting and receiving communications, including a communications manager 1210, an I/O controller 1215, a transceiver 1220, an antenna 1225, memory 1230, and a processor 1240. These components may be in electronic communication via one or more buses (e.g., bus 1245).

The communications manager 1210 may receive a video frame and a PTS frame from a source device, where the PTS frame includes a frame capture time and a frame transmit start time associated with the video frame, transmit the frame latency statistics to the source device, determine a latency metric for the video frame based on the PTS frame and a size of the video frame, and generate frame latency statistics including frame latency information categorized by frame size into one or more categories, where a portion of the frame latency information associated with one of the categories is based on the latency metric for the video frame.

The I/O controller 1215 may manage input and output signals for the device 1205. The I/O controller 1215 may also manage peripherals not integrated into the device 1205. In some cases, the I/O controller 1215 may represent a physical connection or port to an external peripheral. In some cases, the I/O controller 1215 may utilize an operating system such as iOS®, ANDROID®, MS-DOS®, MS-WINDOWS®, OS/2®, UNIX®, LINUX®, or another known operating system. In other cases, the I/O controller 1215 may represent or interact with a modem, a keyboard, a mouse, a touchscreen, or a similar device. In some cases, the I/O controller 1215 may be implemented as part of a processor. In some cases, a user may interact with the device 1205 via the I/O controller 1215 or via hardware components controlled by the I/O controller 1215.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas. In some cases, the wireless device may include a single antenna 1225. However, in some cases the device may have more than one antenna 1225, which may be capable of concurrently transmitting or receiving multiple wireless transmissions.

The memory 1230 may include RAM and ROM. The memory 1230 may store computer-readable, computer-executable software 1235 including instructions that, when executed, cause the processor to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting latency improvement via frame latency feedback).

The software 1235 may include instructions to implement aspects of the present disclosure, including instructions to support wireless communication. The software 1235 may be stored in a non-transitory computer-readable medium such as system memory or other type of memory. In some cases, the software 1235 may not be directly executable by the processor 1240 but may cause a computer (e.g., when compiled and executed) to perform functions described herein.

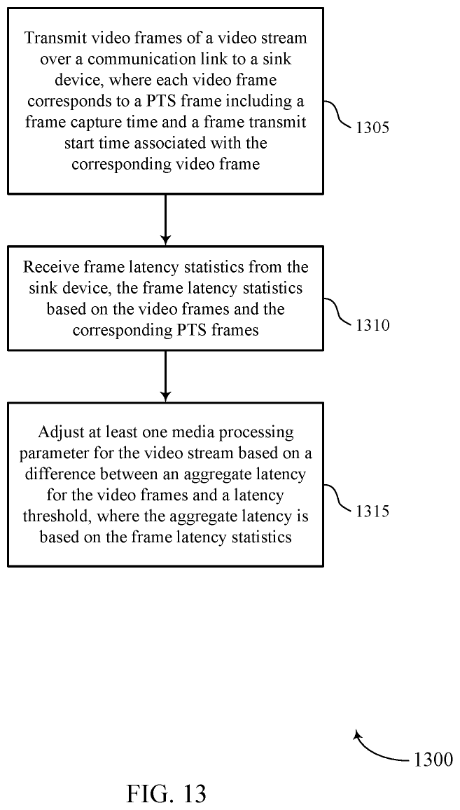

FIG. 13 shows a flowchart illustrating a method 1300 that supports latency improvement via frame latency feedback in accordance with aspects of the present disclosure. The operations of method 1300 may be implemented by a STA 115 or its components as described herein. For example, the operations of method 1300 may be performed by a communications manager as described with reference to FIGS. 9 through 10. In some examples, a STA may execute a set of instructions to control the functional elements of the STA to perform the functions described below. Additionally, or alternatively, a STA may perform aspects of the functions described below using special-purpose hardware.

At 1305, the STA may transmit video frames of a video stream over a communication link to a sink device, where each video frame corresponds to a PTS frame including a frame capture time and a frame transmit start time associated with the corresponding video frame. The operations of 1305 may be performed according to the methods described herein. In some examples, aspects of the operations of 1305 may be performed by a video stream manager as described with reference to FIGS. 9 through 10.

At 1310, the STA may receive frame latency statistics from the sink device, the frame latency statistics based on the video frames and the corresponding PTS frames. The operations of 1310 may be performed according to the methods described herein. In some examples, aspects of the operations of 1310 may be performed by a frame latency manager as described with reference to FIGS. 9 through 10.

At 1315, the STA may adjust at least one media processing parameter for the video stream based on a difference between an aggregate latency for the video frames and a latency threshold, where the aggregate latency is based on the frame latency statistics. The operations of 1315 may be performed according to the methods described herein. In some examples, aspects of the operations of 1315 may be performed by a media processing manager as described with reference to FIGS. 9 through 10.

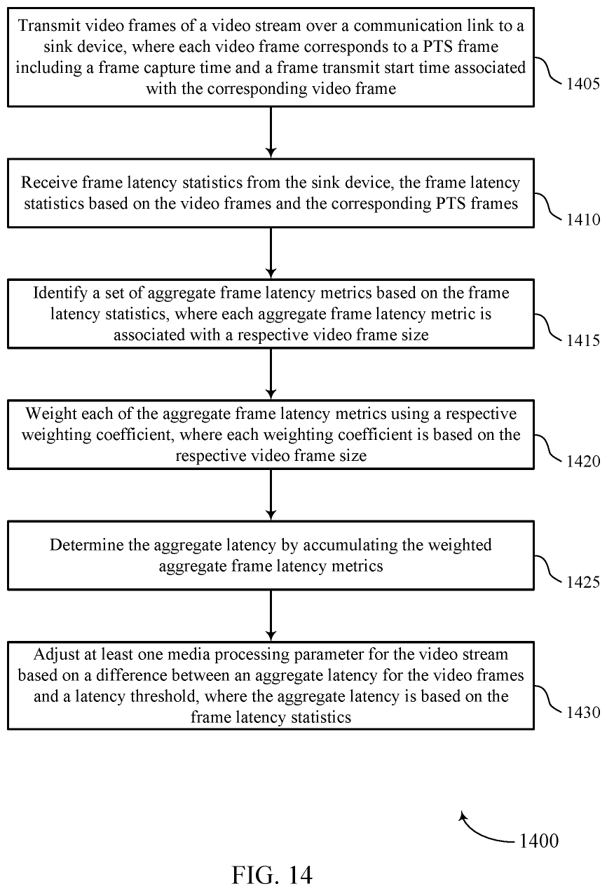

FIG. 14 shows a flowchart illustrating a method 1400 that supports latency improvement via frame latency feedback in accordance with aspects of the present disclosure. The operations of method 1400 may be implemented by a STA 115 or its components as described herein. For example, the operations of method 1400 may be performed by a communications manager as described with reference to FIGS. 9 and 10. In some examples, a STA may execute a set of instructions to control the functional elements of the STA to perform the functions described below. Additionally, or alternatively, a STA may perform aspects of the functions described below using special-purpose hardware.

At 1405, the STA may transmit video frames of a video stream over a communication link to a sink device, where each video frame corresponds to a PTS frame including a frame capture time and a frame transmit start time associated with the corresponding video frame. The operations of 1405 may be performed according to the methods described herein. In some examples, aspects of the operations of 1405 may be performed by a video stream manager as described with reference to FIGS. 9 and 10.

At 1410, the STA may receive frame latency statistics from the sink device, the frame latency statistics based on the video frames and the corresponding PTS frames. The operations of 1410 may be performed according to the methods described herein. In some examples, aspects of the operations of 1410 may be performed by a frame latency manager as described with reference to FIGS. 9 and 10.

At 1415, the STA may identify a set of aggregate frame latency metrics based on the frame latency statistics, where each aggregate frame latency metric is associated with a respective video frame size. The operations of 1415 may be performed according to the methods described herein. In some examples, aspects of the operations of 1415 may be performed by a frame latency manager as described with reference to FIGS. 9 and 10.

At 1420, the STA may weight each of the aggregate frame latency metrics using a respective weighting coefficient, where each weighting coefficient is based on the respective video frame size. The operations of 1420 may be performed according to the methods described herein. In some examples, aspects of the operations of 1420 may be performed by an aggregate latency manager as described with reference to FIGS. 9 and 10.

At 1425, the STA may determine the aggregate latency by accumulating the weighted aggregate frame latency metrics. The operations of 1425 may be performed according to the methods described herein. In some examples, aspects of the operations of 1425 may be performed by an aggregate latency manager as described with reference to FIGS. 9 and 10.

At 1430, the STA may adjust at least one media processing parameter for the video stream based on a difference between an aggregate latency for the video frames and a latency threshold, where the aggregate latency is based on the frame latency statistics. The operations of 1430 may be performed according to the methods described herein. In some examples, aspects of the operations of 1430 may be performed by a media processing manager as described with reference to FIGS. 9 and 10.

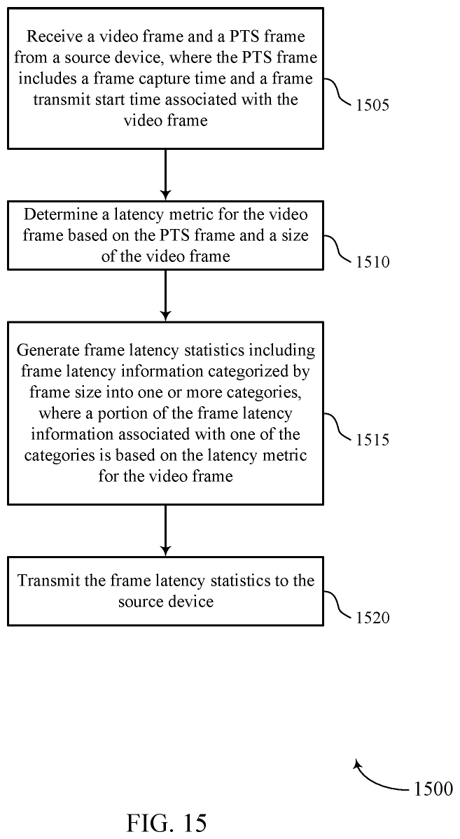

FIG. 15 shows a flowchart illustrating a method 1500 that supports latency improvement via frame latency feedback in accordance with aspects of the present disclosure. The operations of method 1500 may be implemented by a device or its components as described herein. For example, the operations of method 1500 may be performed by a communications manager as described with reference to FIGS. 11 and 12. In some examples, a device may execute a set of instructions to control the functional elements of the device to perform the functions described below. Additionally, or alternatively, a device may perform aspects of the functions described below using special-purpose hardware.

At 1505, the device may receive a video frame and a PTS frame from a source device, where the PTS frame includes a frame capture time and a frame transmit start time associated with the video frame. The operations of 1505 may be performed according to the methods described herein. In some examples, aspects of the operations of 1505 may be performed by a video stream manager as described with reference to FIGS. 11 and 12.

At 1510, the device may determine a latency metric for the video frame based on the PTS frame and a size of the video frame. The operations of 1510 may be performed according to the methods described herein. In some examples, aspects of the operations of 1510 may be performed by a frame latency manager as described with reference to FIGS. 11 and 12.

At 1515, the device may generate frame latency statistics including frame latency information categorized by frame size into one or more categories, where a portion of the frame latency information associated with one of the categories is based on the latency metric for the video frame. The operations of 1515 may be performed according to the methods described herein. In some examples, aspects of the operations of 1515 may be performed by a frame latency statistics manager as described with reference to FIGS. 11 and 12.

At 1520, the device may transmit the frame latency statistics to the source device. The operations of 1520 may be performed according to the methods described herein. In some examples, aspects of the operations of 1520 may be performed by a video stream manager as described with reference to FIGS. 11 and 12.

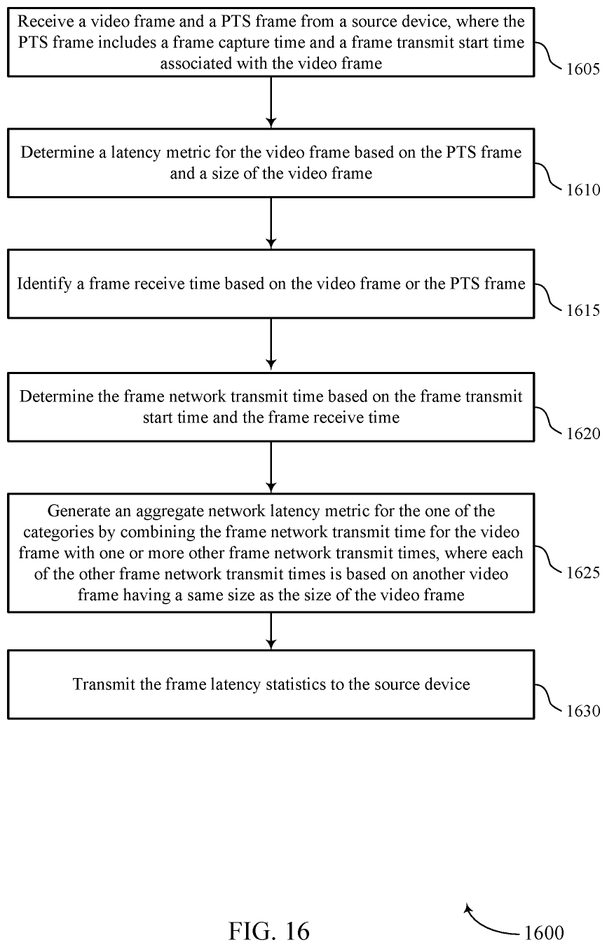

FIG. 16 shows a flowchart illustrating a method 1600 that supports latency improvement via frame latency feedback in accordance with aspects of the present disclosure. The operations of method 1600 may be implemented by a device or its components as described herein. For example, the operations of method 1600 may be performed by a communications manager as described with reference to FIGS. 11 and 12. In some examples, a device may execute a set of instructions to control the functional elements of the device to perform the functions described below. Additionally, or alternatively, a device may perform aspects of the functions described below using special-purpose hardware.

At 1605, the device may receive a video frame and a PTS frame from a source device, where the PTS frame includes a frame capture time and a frame transmit start time associated with the video frame. The operations of 1605 may be performed according to the methods described herein. In some examples, aspects of the operations of 1605 may be performed by a video stream manager as described with reference to FIGS. 11 and 12.

At 1610, the device may determine a latency metric for the video frame based on the PTS frame and a size of the video frame. The operations of 1610 may be performed according to the methods described herein. In some examples, aspects of the operations of 1610 may be performed by a frame latency manager as described with reference to FIGS. 11 and 12.

At 1615, the device may identify a frame receive time based on the video frame or the PTS frame. The operations of 1615 may be performed according to the methods described herein. In some examples, aspects of the operations of 1615 may be performed by a video frame manager as described with reference to FIGS. 11 and 12.

At 1620, the device may determine the frame network transmit time based on the frame transmit start time and the frame receive time. The operations of 1620 may be performed according to the methods described herein. In some examples, aspects of the operations of 1620 may be performed by a network latency manager as described with reference to FIGS. 11 and 12.

At 1625, the device may generate an aggregate network latency metric for the one of the categories by combining the frame network transmit time for the video frame with one or more other frame network transmit times, where each of the other frame network transmit times is based on another video frame having a same size as the size of the video frame. The operations of 1625 may be performed according to the methods described herein. In some examples, aspects of the operations of 1625 may be performed by an aggregate latency manager as described with reference to FIGS. 11 and 12.

At 1630, the device may transmit the frame latency statistics to the source device. In some cases, the frame latency statistics may include the aggregate network latency metric, as well as other aggregate network latency metrics associated with other frame sizes. The operations of 1630 may be performed according to the methods described herein. In some examples, aspects of the operations of 1630 may be performed by a video stream manager as described with reference to FIGS. 11 and 12.

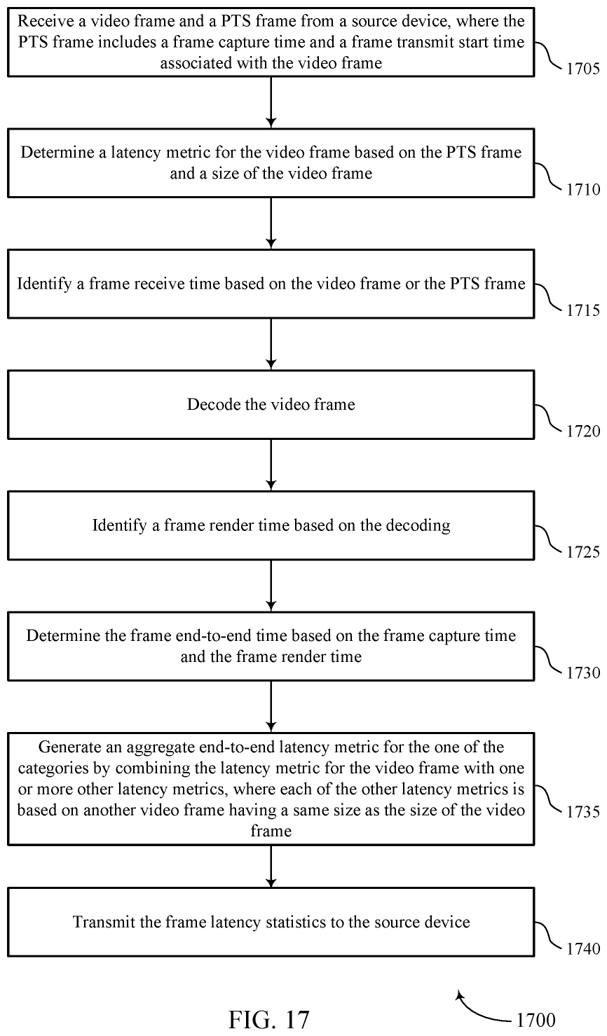

FIG. 17 shows a flowchart illustrating a method 1700 that supports latency improvement via frame latency feedback in accordance with aspects of the present disclosure. The operations of method 1700 may be implemented by a device or its components as described herein. For example, the operations of method 1700 may be performed by a communications manager as described with reference to FIGS. 11 and 12. In some examples, a device may execute a set of instructions to control the functional elements of the device to perform the functions described below. Additionally, or alternatively, a device may perform aspects of the functions described below using special-purpose hardware.

At 1705, the device may receive a video frame and a PTS frame from a source device, where the PTS frame includes a frame capture time and a frame transmit start time associated with the video frame. The operations of 1705 may be performed according to the methods described herein. In some examples, aspects of the operations of 1705 may be performed by a video stream manager as described with reference to FIGS. 11 and 12.

At 1710, the device may determine a latency metric for the video frame based on the PTS frame and a size of the video frame. The operations of 1710 may be performed according to the methods described herein. In some examples, aspects of the operations of 1710 may be performed by a frame latency manager as described with reference to FIGS. 11 and 12.

At 1715, the device may identify a frame receive time based on the video frame or the PTS frame. The operations of 1715 may be performed according to the methods described herein. In some examples, aspects of the operations of 1715 may be performed by a video frame manager as described with reference to FIGS. 11 and 12.

At 1720, the device may decode the video frame. The operations of 1720 may be performed according to the methods described herein. In some examples, aspects of the operations of 1720 may be performed by a decoder as described with reference to FIGS. 11 and 12.

At 1725, the device may identify a frame render time based on the decoding. The operations of 1725 may be performed according to the methods described herein. In some examples, aspects of the operations of 1725 may be performed by a video frame manager as described with reference to FIGS. 11 and 12.

At 1730, the device may determine the frame end-to-end time based on the frame capture time and the frame render time. The operations of 1730 may be performed according to the methods described herein. In some examples, aspects of the operations of 1730 may be performed by an end-to-end latency manager as described with reference to FIGS. 11 and 12.

At 1735, the device may generate an aggregate end-to-end latency metric for the one of the categories by combining the frame end-to-end time for the video frame with one or more other frame end-to-end times, where each of the other frame end-to-end times are based on another video frame having a same size as the size of the video frame. The operations of 1735 may be performed according to the methods described herein. In some examples, aspects of the operations of 1735 may be performed by an aggregate latency manager as described with reference to FIGS. 11 and 12.

At 1740, the device may transmit the frame latency statistics to the source device. In some cases, the frame latency statistics may include the aggregate end-to-end latency metric, as well as other aggregate end-to-end latency metrics associated with other frame sizes. The operations of 1740 may be performed according to the methods described herein. In some examples, aspects of the operations of 1740 may be performed by a video stream manager as described with reference to FIGS. 11 and 12.

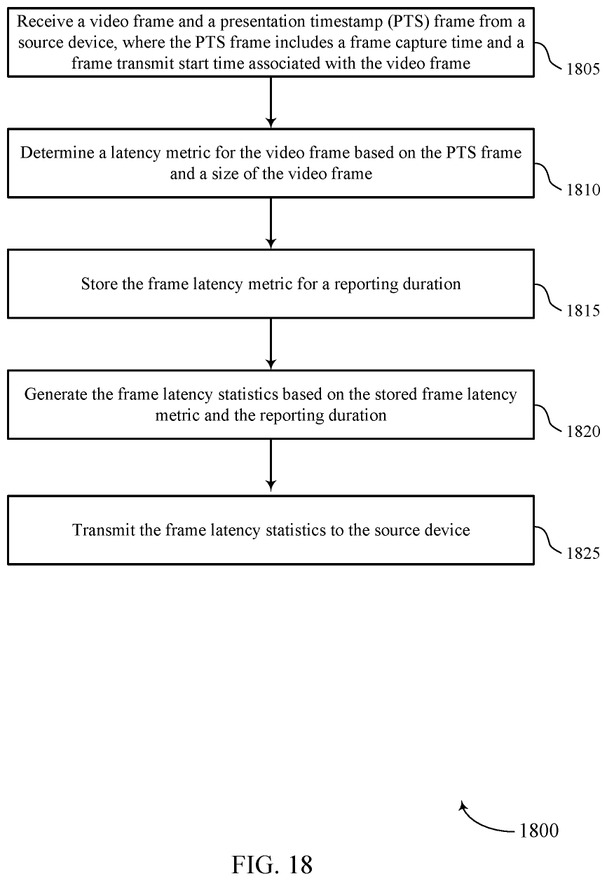

FIG. 18 shows a flowchart illustrating a method 1800 that supports latency improvement via frame latency feedback in accordance with aspects of the present disclosure. The operations of method 1800 may be implemented by a device or its components as described herein. For example, the operations of method 1800 may be performed by a communications manager as described with reference to FIGS. 11 and 12. In some examples, a device may execute a set of instructions to control the functional elements of the device to perform the functions described below. Additionally, or alternatively, a device may perform aspects of the functions described below using special-purpose hardware.

At 1805, the device may receive a video frame and a PTS frame from a source device, where the PTS frame includes a frame capture time and a frame transmit start time associated with the video frame. The operations of 1805 may be performed according to the methods described herein. In some examples, aspects of the operations of 1805 may be performed by a video stream manager as described with reference to FIGS. 11 and 12.

At 1810, the device may determine a latency metric for the video frame based on the PTS frame and a size of the video frame. The operations of 1810 may be performed according to the methods described herein. In some examples, aspects of the operations of 1810 may be performed by a frame latency manager as described with reference to FIGS. 11 and 12.

At 1815, the device may store the frame latency metric for a reporting duration. The operations of 1815 may be performed according to the methods described herein. In some examples, aspects of the operations of 1815 may be performed by an aggregate latency manager as described with reference to FIGS. 11 and 12.

At 1820, the device may generate the frame latency statistics based on the frame latency metrics (e.g., including the frame latency metric stored at 1815) stored for the reporting duration (e.g., which may then be combined or aggregated during the reporting duration, or upon expiration of the reporting duration). The operations of 1820 may be performed according to the methods described herein. In some examples, aspects of the operations of 1820 may be performed by a frame latency statistics manager as described with reference to FIGS. 11 and 12.

At 1825, the device may transmit the frame latency statistics to the source device (e.g., upon expiration of the reporting duration). The operations of 1825 may be performed according to the methods described herein. In some examples, aspects of the operations of 1825 may be performed by a video stream manager as described with reference to FIGS. 11 and 12.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, system 100 of FIG. 1 and process flow 200 of FIG. 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a source device, comprising:
transmitting video frames of a video stream over a communication link to a sink device, wherein each video frame corresponds to a presentation timestamp (PTS) frame comprising a frame capture time and a frame transmit start time associated with the corresponding video frame;
receiving frame latency statistics from the sink device, the frame latency statistics based at least in part on the video frames and the corresponding PTS frames;
identifying a plurality of aggregate frame latency metrics based at least in part on the frame latency statistics, wherein each aggregate frame latency metric is associated with a respective video frame size and comprises aggregate latency information corresponding to the respective video frame size; and
adjusting at least one media processing parameter for the video stream based at least in part on a difference between an aggregate latency for the video frames and a latency threshold, wherein the aggregate latency is based at least in part on the plurality of aggregate frame latency metrics.

2. (canceled)

3. The method of claim 1, further comprising:
weighting each of the aggregate frame latency metrics using a respective weighting coefficient, wherein each weighting coefficient is based at least in part on the respective video frame size; and
determining the aggregate latency by accumulating the weighted aggregate frame latency metrics.

4. The method of claim 3, wherein at least one weighting coefficient, or the latency threshold, or a combination thereof is based at least in part on a target latency associated with the video stream.

5. The method of claim 1, wherein the aggregate frame latency metrics include one or more of:
an aggregate network latency metric, an aggregate end-to-end metric, or some combination thereof.

6. The method of claim 1, wherein adjusting the at least one media processing parameter comprises:
adjusting one or more of an encoding bitrate for the video stream, a quantization parameter for the video stream, a frame resolution parameter for the video stream, or a combination thereof.

7. A method for wireless communication at a sink device, comprising:
receiving a video frame and a presentation timestamp (PTS) frame from a source device, wherein the PTS frame comprises a frame capture time and a frame transmit start time associated with the video frame;
determining a latency metric for the video frame based at least in part on the PTS frame and a size of the video frame;
generating frame latency statistics comprising frame latency information categorized by frame size into one or more categories, wherein a portion of the frame latency information associated with one of the categories is based at least in part on the latency metric for the video frame; and
transmitting the frame latency statistics to the source device.

8. The method of claim 7, wherein generating the frame latency statistics comprises:
generating an aggregate frame latency metric for the one of the categories by combining the latency metric for the video frame with one or more other latency metrics, wherein each of the other latency metrics is based at least in part on another video frame having a same size as the size of the video frame.

9. The method of claim 8, further comprising:
identifying a frame receive time based at least in part on the video frame or the PTS frame;
decoding the video frame; and
identifying a frame render time based at least in part on the decoding.

10. The method of claim 9, wherein the latency metric comprises a frame network transmit time, the method further comprising:
determining the frame network transmit time based at least in part on the frame transmit start time and the frame receive time.

11. The method of claim 10, wherein the aggregate frame latency metric comprises an aggregate network latency metric, the method further comprising:
generating the aggregate network latency metric for the one of the categories by combining the frame network transmit time for the video frame with one or more other frame network transmit times, wherein each of the other frame network transmit times is based at least in part on another video frame having a same size as the size of the video frame.

12. The method of claim 9, wherein the latency metric comprises a frame end-to-end time, the method further comprising:
determining the frame end-to-end time based at least in part on the frame capture time and the frame render time.

13. The method of claim 12, wherein the aggregate frame latency metric comprises an aggregate end-to-end latency metric, the method further comprising:
generating the aggregate end-to-end latency metric for the one of the categories by combining the frame end-to-end time for the video frame with one or more other frame end-to-end times, wherein each of the other frame end-to-end times is based at least in part on another video frame having a same size as the size of the video frame.

14. The method of claim 7, wherein the frame latency information categorized by frame size into one or more categories comprises one or more aggregate frame latency metrics categorized by frame size into the one or more categories, one or more aggregate network latency metrics categorized by frame size into the one or more categories, or some combination thereof.

15. The method of claim 7, further comprising:
storing the latency metric for a reporting duration; and
generating the frame latency statistics based at least in part on the stored latency metric and the reporting duration.

16. The method of claim 15, further comprising:
reducing the reporting duration based at least in part on the latency metric, wherein the frame latency statistics are generated based at least in part on the reduced reporting duration.

17. The method of claim 7, wherein generating the frame latency statistics comprises:
combining respective latency metrics for each of a plurality of frame sizes; and
generating an aggregate frame latency metric for each of the frame sizes based at least in part on the combining, wherein the frame latency statistics comprise the aggregate frame latency metrics categorized by their respective frame size.

18. An apparatus for wireless communication, comprising:
a processor,
memory in electronic communication with the processor; and
instructions stored in the memory and executable by the processor to cause the apparatus to:
transmit video frames of a video stream over a communication link to a sink device, wherein each video frame corresponds to a presentation timestamp (PTS) frame comprising a frame capture time and a frame transmit start time associated with the corresponding video frame;
receive frame latency statistics from the sink device, the frame latency statistics based at least in part on the video frames and the corresponding PTS frames;
identify a plurality of aggregate frame latency metrics based at least in part on the frame latency statistics, wherein each aggregate frame latency metric is associated with a respective video frame size and comprises aggregate latency information corresponding to the respective video frame size; and
adjust at least one media processing parameter for the video stream based at least in part on a difference between an aggregate latency for the video frames and a latency threshold, wherein the aggregate latency is based at least in part on the plurality of aggregate frame latency metrics.

19. (canceled)

20. The apparatus of claim 18, wherein the instructions to adjust the at least one media processing parameter are executable by the processor to cause the apparatus to:
adjust one or more of an encoding bitrate for the video stream, a quantization parameter for the video stream, a frame resolution parameter for the video stream, or a combination thereof.
